(19) United States
(12) Patent Application Publication
(10) Pub. No.: US 2007/0114311 A1
(43) Pub. Date: May 24, 2007

(54) Stock re-pulper

(76) Inventor: Hiromi Fukudome, Hiroshima-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/359,455

(22) Filed: Feb. 23, 2006

(30) Foreign Application Priority Data
Nov. 21, 2005 (JP) 2005-336249

(51) Int. Cl. B02C 23/36

(52) U.S. Cl. 241/46.017

(57) ABSTRACT

The present invention relates to a stock re-pulper designed to macerate stock put into a stock tub. The stock re-pulper comprises first and second porous plate disposed in the stock tub and respectively having first and second holes, first macerating blades disposed to confront one surface of the first porous plate and made to be rotated in proximity to a first open area of the first porous plate, second macerating blades disposed to confront one surface of the second porous plate in proximity to a second open area and made to be rotated concentrically with respect to the center of rotation of the first macerating blades, and a pump blade disposed to confront the other surface of the first porous plate in proximity to the first open area and made to be rotated concentrically with respect to the center of rotation of the first macerating blades. With this construction, when a drive source is put into operation, the stock is positively guided between the first macerating blades and the first porous plate and positively guided between the first porous plate and the pump blade and further guided between the second macerating blades and the second porous plate, which can provide a high maceration efficiency while suppressing the power needed for the maceration processing.

### BACKGROUND OF THE INVENTION

(1) Field of the Invention

The present invention relates to a stock re-pulper for re-pulping stock such as paper pulp, collection paper and broke in a paper machine.

(2) Description of the Related Art

FIGS. 14 and 15 are schematic illustrations of a construction of a conventional stock re-pulper 500, and FIG. 16 is a partially enlarged perspective view (partially sectional view) showing an essential part of this stock re-pulper 500, where broken line arrows indicate flows of stock. The stock re-pulper 500 shown in FIGS. 14 to 16 is for stock disaggregatable in a relatively easy way.

As FIG. 14 shows, this stock re-pulper 500 is equipped with a porous plate 503 at a bottom portion of a tub 501 made to accommodate stock. In addition, a large number of holes are made in this porous plate 503 and a rotor 502 is located at a central portion thereof. Still additionally, six macerating blades 521 are protrusively formed outwardly on the rotor 502. The structures of the rotor 502 and the porous plate 503 can be changed into various modes according to the degree of difficulty of the stock re-pulping.

Furthermore, as shown in FIG. 15, a motor 508 is connected to a rotary shaft 506 of the rotor 502 so that the rotor 502 receives power from this motor 508 for rotation and the rotation of the rotor 502 also rotate the macerating blades 521.

More concretely, as shown in FIG. 16, the rotor 502 is attached through shims 561 to a flange 502A fixedly secured to the rotary shaft 506 so that the space between the porous plate 503 and the macerating blades 521 is properly adjustable by increasing/decreasing the number of shims 561 or changing the thickness of the shims 561.

Moreover, the rotation of the macerating blades 521 agitates stock supplied together with water serving as a dilute solution into the tub 501, thereby conducting rough maceration processing. In general, the ratio of water and stock is set such that the stock has a concentration of approximately 3 to 8% with respect to water.

Still furthermore, as shown in FIG. 14, on the bottom portion of the tub 501 there are formed turning plates 507 extending radially from the center of the tub 501 and protruding toward the interior of the tub 501, which turns a circumferential flow of stock, occurring in the interior of the tub 501 due to the rotation of the rotor 502 and the macerating blades 521, to a longitudinal flow.

Thus, the stock is agitated while circulating in a circumferential direction or longitudinal direction in the interior of the tub 501, thereby undergoing the maceration processing, while the maceration processing is further conducted between the macerating blades 521 which is in rotation and the porous plate 503 which is in a fixed state.

In addition, after the rotation of the rotor 502 for a predetermined period of time, a valve (not shown) provided in an output pipe 505 of a chamber 509 positioned on a rear side of the porous plate 503 is opened and, in this state, the stock is dischargeable through the output pipe 505.

That is, in this stock re-pulper 500, the maceration of the stock is mainly carried out in a manner such that the macerating blades 521 mounted on the rotor 502 and the holes 514 made in the porous plate 503 are in cooperation with each other. A little more detailed description will be given hereinbelow of this point. The stock flows into the gap between the macerating blades 521 and the porous plate 503 due to the rotation of the rotor 502. Moreover, this stock is lacerated between the lower edges of the macerating blades 521 and the circumferential edges of the holes 514 so as to reduce the size thereof, thereby performing the maceration.

Meanwhile, FIG. 17 is a perspective view (partially sectional view) showing a construction of an essential part of a stock re-pulper 600 to be employed for the maceration of relatively hard-to-dissolve stock.

As shown in FIG. 17, in this stock re-pulper 600, a plurality of elongated holes 614 extending radially are made in the porous plate 603 and, on a rear surface (surface opposite to the surface confronting macerating blades 621) of the porous plate 603, a ring-like stationary blade 681 is mounted on an outer-circumferential side relative to the elongated holes 614.

In addition, a flange 602A of the rotor 602 is made to extend from a center side thereof toward the rear surface of the porous plate 603, and a ring-like rotary blade 682 is mounted on an outer-circumferential portion thereof so as to confront the aforesaid stationary blade 681.

With the construction of this stock re-pulper 600, the rotation of the rotor 602 causes the stock flowing in the gap between the macerating blades 621 and the porous plate 603 to be lacerated by the lower edges of the macerating blades 621 and the circumferential edges of the elongated holes 614, thereby carrying out the maceration processing.

Following this, the stock after passing through the elongated holes 614 is macerated more finely between the stationary blade 681 and the rotary blade 682 and then returned through a circulation opening 660, bored in an outer-circumferential portion of the porous plate 603, to a tub (not shown).

When the maceration processing reaches completion by the rotation of the rotor 602 for a predetermined period of time, a valve (not shown) provided in an output pipe (not shown) of the chamber 609 located on a rear side of the porous plate 603 is opened to discharge the stock which is in a macerated condition.

Furthermore, FIG. 18 is a perspective view (partially sectional view) showing a construction of an essential part of a stock re-pulper 700 to be employed for the maceration of harder-to-dissolve stock than the stock to be macerated by the above-mentioned stock re-pulper 600.

As shown in FIG. 18, a plurality of round holes 714 are formed in a porous plate 703. A flange 702A of a rotor 702 is formed so as to extend from a central axis side of the rotor 702 toward a rear surface of the porous plate 703.

Moreover, a rotary blade (pump blade) 725 is mounted on an outer-circumferential side of the rotor 702 so as to confront a rear surface (surface opposite to the surface confronting macerating blades 721) of the aforesaid porous plate 703. This pump blade 725 is composed of a ring-like base portion 725A and a plurality of blade portions 725B formed at a given interval on an upper surface of the base 725A.

With the construction of this stock re-pulper 700, the rotation of the rotor 702 enables the stock flowing in the gap between the macerating blades 721 and the porous plate 703 to be lacerated between lower edges of the macerating blades 721 and the circumferential edges of the round holes 714, thereby conducting the maceration.

Following this, the stock after passing through the round holes 714 is macerated more finely between the blade portions 725B of the pump blade 725 and the round holes 714 and then returned through a circulation opening 760, formed in an outer-circumferential portion of a chamber 709 located on a rear side of the porous plate 703, to a tub (not shown).

The technique related to the foregoing conventional stock re-pulper shown in FIGS. 14 to 16 is disclosed in Japanese Patent No. 3581686.

As described above, the macerating blades 521 and 621 provided in the conventional stock re-pulper 500 shown in FIGS. 14 to 16 and in the conventional stock re-pulper 600 shown in FIG. 17 have a function to agitate the stock in a tub while lacerating and, in addition, a function to further promote the stock maceration in cooperation with the porous plates 503 and 603.

However, in these stock re-pulpers 500 and 600, if the agitating capability of each of the macerating blades 521 and 621 is low, then difficulty is encountered in concentrating the stock at a portion (working portion) of each of the porous plates 503 and 603 where the holes 514, 614 are formed. This because the stock rises when the macerating blades 521, 621 have a low agitation capability.

For solving such a problem, although it can be considered to employ a method of enhancing the agitation capability of the macerating blades 521, 621, this method naturally requires the enhancement of a driving force with respect to the rotors 502, 602 and it is not preferable in light of energy-saving.

Moreover, when the concentration of the stock is high with respect to the dilute solution, a large driving torque is required for rotating the rotor 502, 602 and, in this case, the further enhancement of the driving torque produces no practical solutions and leads eventually to insufficient maceration processing or prolongation of time needed for the maceration processing.

Thus, the conventional stock re-pulpers 500 and 600 do not always produce good maceration effects.

In addition, although the conventional stock re-pulper 500 shown in FIG. 16 is designed to macerate the stock between the macerating blades 521 and the porous plate 503, the stock in this stock re-pulper 500 flows more strongly in radial directions in comparison with circumferential directions and, hence, the stock is collected toward the outer-circumferential side, which makes it difficult for the stock to flow in the gap between the macerating blades 521 and the porous plate 503.

Still additionally, the conventional stock re-pulper 600 shown in FIG. 17 is equipped with, in addition to the macerating blades 621 and the porous plate 603, the stationary blade 681 and the rotary blade 682, which can provide an advantage in that even the maceration of hard-to-dissolve stock becomes feasible.

However, since a portion (working portion) where the stationary blade 681 and the rotary blade 682 confront each other is positioned at an outer-circumferential side remote from the center of rotation of the rotor 602, there exists a need for the enhancement of the driving torque for rotating the rotor 602.

Yet additionally, in this stock re-pulper 600, if the stock flowing through the elongated holes 614 into a lower surface of the porous plate 603 is relatively large, this stock cannot enter the gap between the stationary blade 681 and the rotary blade 682.

Accordingly, there is a problem which arises with the stock re-pulper 600 in that the non-macerated stock tends to accumulate on an inner-circumferential side relative to the stationary blade 681 and the rotary blade 682.

On the other hand, since the conventional stock re-pulper 700 shown in FIG. 18 is equipped with the macerating blades 721 and with the rotary blade (pump blade) 725 on the rear side of the porous plate 703, there is an advantage in that it is possible to macerate even stock the stock re-pulper 600 shown in FIG. 17 is hard to macerate.

However, in this stock re-pulper 700, since the stock flowing in the chamber 709 through the round holes 714 made at a portion which is not positioned on the rotation trajectory of the blade portions 725B of the pump blade 725 returns directly through the circulation opening 760 to the tub without undergoing the maceration processing by the porous plate 703 and the pump blade 725, the maceration effectiveness is not high. In addition, since the stock undergoing the maceration processing by the blade portions 725B of the pump blade 725 and the porous plate 703 is also returned through the circulation opening 760 to the tub and again undergoes the maceration processing, the maceration efficiency is not high.

Moreover, although it can be considered that the diameters of the porous plate 703 and the pump blade 725 are enlarged or the rotational speed of the pump blade 725 is increased for improving the maceration effectiveness of the porous plate 703 and the pump blade 725, these methods require larger power for the rotation of the rotor 702, and they are also undesirable in light of energy-saving.

### SUMMARY OF THE INVENTION

The present invention has been developed with a view to eliminating the above-mentioned problems, and it is therefore an object of the invention to provide a stock re-pulper capable of producing a high maceration efficiency while suppressing the power needed for the maceration processing.

For this purpose, in accordance with an aspect of the present invention, there is provided a stock re-pulper for macerating stock put together with a dilute solution into a stock tub, comprising a first porous plate disposed in the stock tub and having first holes formed therein, first macerating blades disposed to confront one surface of the first porous plate and made to be rotated in proximity to a first open area of the first porous plate where the first holes are formed, a pump blade disposed to confront the other surface of the first porous plate in proximity to the first open area and made to be rotated concentrically with respect to the center of rotation of the first macerating blades, a second porous plate disposed in the stock tub and having second holes formed therein, second macerating blades disposed to confront one surface of the second porous plate in proximity to a second open area where the second holes are formed and made to be rotated concentrically with respect to the center of rotation of the first macerating blades, and a drive source for rotating the first macerating blades, the pump blade and the second macerating blades.

This construction can rotate the first macerating blades, the pump blade and the second macerating blades through the rotation of the drive source so that the stock put together with the dilute solution into the tub is positively guided between the first macerating blades, which are in rotation, and the first porous plate (to a first working section) and positively guided between the first porous plate and the pump blade which is in rotation (to a second working section) and further guided between the second macerating blades, which are in rotation, and the second porous plate (to a third working section), which can provide a high maceration effectiveness on the stock while suppressing the power needed for the maceration processing.

In addition, third macerating blades are provided above the first macerating blades and are made such that a distance from the center of rotation of the first macerating blades to an outer-circumferential end of the third macerating blades is shorter than a distance from the center of rotation of the first macerating blades to an outer-circumferential end of the first macerating blades.

Still additionally, fourth macerating blades are provided above the first macerating blades and are made such that a distance from the center of rotation of the first macerating blades to an outer-circumferential end of the fourth macerating blades is shorter than a distance from the center of rotation of the first macerating blades to an outer-circumferential end of the first macerating blades and a height of the fourth macerating blades is lower than a height of the third macerating blades.

Yet additionally, the first macerating blades are composed of a plurality of blades, and the third macerating blades and the fourth macerating blades are alternately disposed above the plurality of first macerating blades.

This construction enables the stock put together with the dilute solution into the tub to be agitated and macerated in a better condition.

Moreover, the second macerating blades have blade portions protruding toward the second porous plate, and the blade portions of the second macerating blades are made such that a gap relative to the second porous plate becomes gradually wider toward a downstream side of the second porous plate.

This enables a negative pressure to occur between the blade portions and the second porous plate, which prevents the stock from being getting jammed in the second holes made in the second porous plate.

Still moreover, an open area of the second holes is smaller than an open area of the first holes.

Thus, since the open area of the second holes is smaller than the open area of the first holes, only the stock undergoing the rough maceration processing to the extent that it can pass through the first holes can reach the second porous plate and, following this, the stock passing through the second holes formed in the second porous plate, i.e., only the stock undergoing the fine maceration processing to the extent that it can pass through the second holes, can be handled as the stock the maceration processing of which has reached completion.

Yet moreover, each of the first holes is formed as an elongated hole extending in a substantially radial direction of the first porous plate and the long axis of the elongated hole is inclined in a range from larger than 0 degree to not larger than 20 degrees with respect to the first macerating blades.

This enables the first macerating blades which are in rotation to cut through the first holes at a predetermined angle. That is, this enables the first macerating blades and the first holes forming elongated holes to cooperate with each other like two edges of scissors so that the stock can be lacerated by a large force between the first macerating blades and the first holes (at a first working section), thereby enhancing the maceration efficiency.

Furthermore, each of the second holes is formed as an elongated hole extending in a substantially radial direction of the second porous plate and the long axis of the elongated hole is inclined in a range from larger than 0 degree to not larger than 20 degrees with respect to the second macerating blades.

This enables the second macerating blades which are in rotation to cut through the second holes at a predetermined angle. That is, this enables the second macerating blades and the second holes forming elongated holes to cooperate with each other like two edges of scissors so that the stock can be lacerated by a large force between the second macerating blades and the second holes (at a second working section) thereby enhancing the maceration efficiency.

Still furthermore, each of the second holes is formed as a round hole having a generally complete round configuration.

This enables the second holes to be bored easily, which improves the production efficiency and contributes to the cost reduction.

Yet furthermore, the second porous plate is formed into a cylindrical configuration whose longitudinal central axis coincides with the axis of rotation of the first macerating blades, and the second macerating blades are made to be rotated on the inner-circumferential side of the second porous plate having the cylindrical configuration.

This enables a centrifugal force to be applied to the stock, thereby guiding more stock the second porous plate having the cylindrical configuration.

In addition, the second macerating blades include the plurality of blade portions and a groove portion is formed between the plurality of blade portions.

This can enhance the maceration processing efficiency. A negative pressure occurs in the groove portions made among the blade portions of the second macerating blades, which can prevent the stock from being getting jammed in the second holes made in the second porous plate and blow away the stock, accumulated on the second porous plate without passing through the second holes, through the groove portions to the outer-curmferential side of the second porous plate.

Still additionally, each of the first holes is formed to have a hole width in a range from 3 mm to 40 mm, and each of the second holes is formed to have a hole width in a range from 0.15 mm to 16 mm, and the rates of open areas of the first and second porous plates are set at values in a range from 10% to 50%.

This can provide a high maceration efficiency while securing the rigidities of the first and second porous plates.

Yet additionally, an angle made between an outer edge portion of each of the third and fourth macerating blades and an upper surface portion of the first macerating blades is set at a right angle or an acute angle.

This enables an outer edge portion of each of the third and fourth macerating blades to have an pointed configuration, which lacerates the stock in a good condition for achieving the efficient maceration processing.

Moreover, the stock re-pulper further comprises an output pipe which is a passage disposed on the other surface side of the second porous plate opposite to the one surface thereof and which is made to discharge the stock, after passing through the second holes from the one surface side of the second porous plate to the other surface side thereof, to the external, and circulation holes made in the first porous plate to be positioned on an outer-circumferential side of the first porous plate with respect to the first open area thereof to make communication between the other surface side of the first porous plate and the interior of the tub.

Thus, the stock macerated minutely to the extent that it can pass through the second holes, i.e., only the stock after macerated, can be discharged to the external. In addition, the stock (i.e., semi-macerated stock) macerated to the extent that it can pass through the first holes but non-macerated minutely to the extent that it can pass through the second holes can be returned to the interior of the tub, which enables conducting the maceration processing in a continuous running fashion.

### BRIEF DESCRIPTION OF THE DRAWINGS

FIG. 1 is a top view illustratively showing the entire construction of a stock re-pulper (stock macerating apparatus) according to an embodiment of the present invention;

FIG. 2 is a top view illustratively showing a construction of an essential part of a stock re-pulper according to an embodiment of the present invention;

FIG. 3 is a cross-sectional view illustratively showing the entire construction of a stock re-pulper according to an embodiment of the present invention, and is a cross-sectional view taken along arrows III-III of FIG. 1;

FIG. 4 is a cross-sectional view illustratively showing a construction of an essential part of a stock re-pulper according to an embodiment of the present invention;

FIG. 5 is a plan view illustratively showing a construction of an essential part of a stock re-pulper according to an embodiment of the present invention and showing a portion of a pump blade;

FIG. 6 is a plan view illustratively showing a construction of an essential part of a stock re-pulper according to an embodiment of the present invention, and showing second macerating blades;

FIG. 7 is a cross-sectional view illustratively showing a construction of an essential part of a stock re-pulper according to an embodiment of the present invention, and is a cross-sectional view taken along arrows VII-VII of FIG. 4;

FIG. 8 is a perspective view illustratively showing a construction of an essential part of a stock re-pulper according to an embodiment of the present invention, and mainly showing third macerating blades;

FIG. 9 is a perspective view illustratively showing a construction of an essential part of a stock re-pulper according to an embodiment of the present invention, and mainly showing fourth macerating blades;

FIG. 10 is a plan view illustratively showing a portion of a first hole-made plate of a stock re-pulper according to an embodiment of the present invention;

FIG. 11 is a cross-sectional view illustratively showing an essential part of a stock re-pulper according to a modification of the present invention;

FIG. 12 is a cross-sectional view illustratively showing an essential part of a stock re-pulper according to a modification of the present invention;

FIG. 13 is a plan view illustratively showing a portion of a first hole-made plate of a stock re-pulper according to a modification of the present invention;

FIG. 14 is a top view illustratively showing a construction of a conventional stock re-pulper;

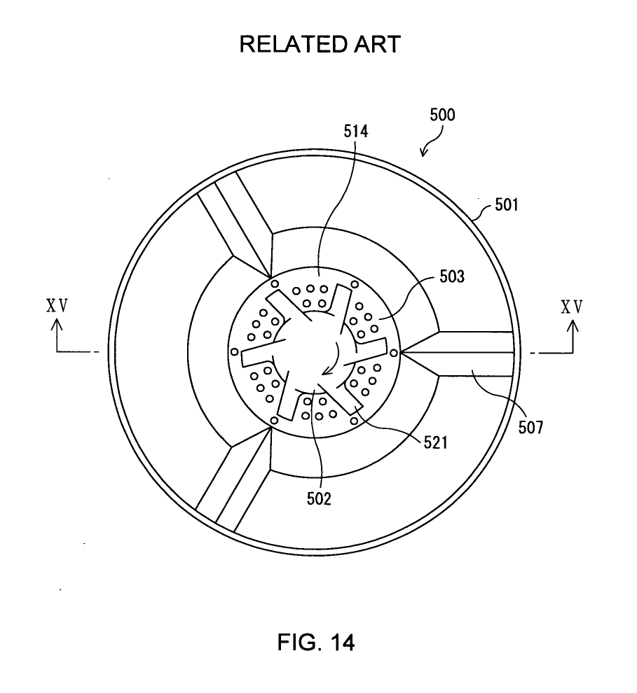

FIG. 15 is a cross-sectional view illustratively showing a construction of a conventional stock re-pulper, and is a cross-sectional view taken along arrows XV-XV of FIG. 14;

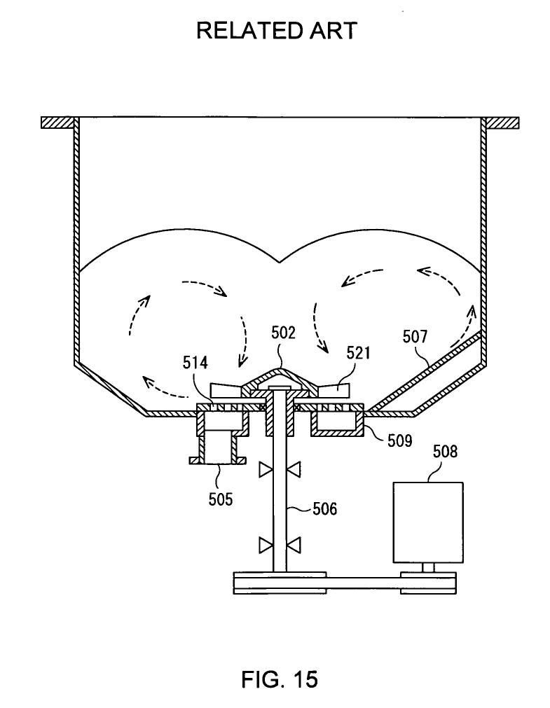

FIG. 16 is a perspective view (partially sectional view) showing a construction of an essential part of a conventional stock re-pulper;

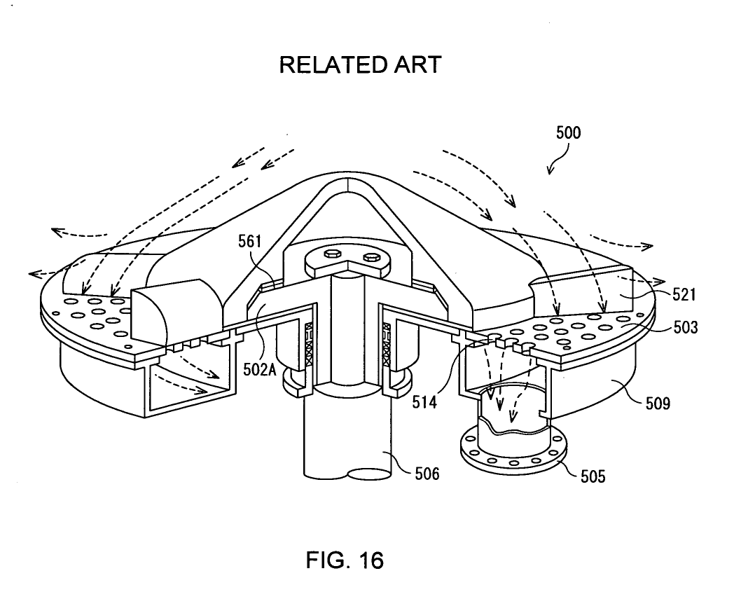

FIG. 17 is a perspective view (partially sectional view) showing a construction of an essential part of a conventional stock re-pulper; and

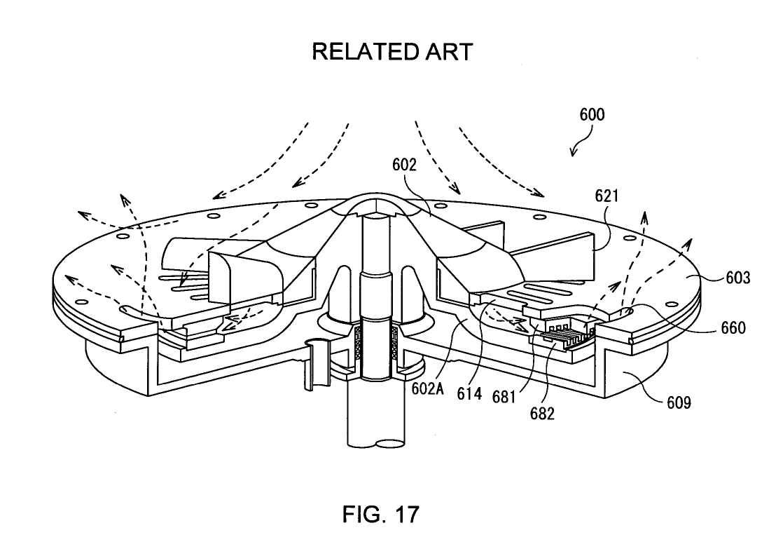

FIG. 18 is a perspective view (partially sectional view) showing a construction of an essential part of a conventional stock re-pulper.

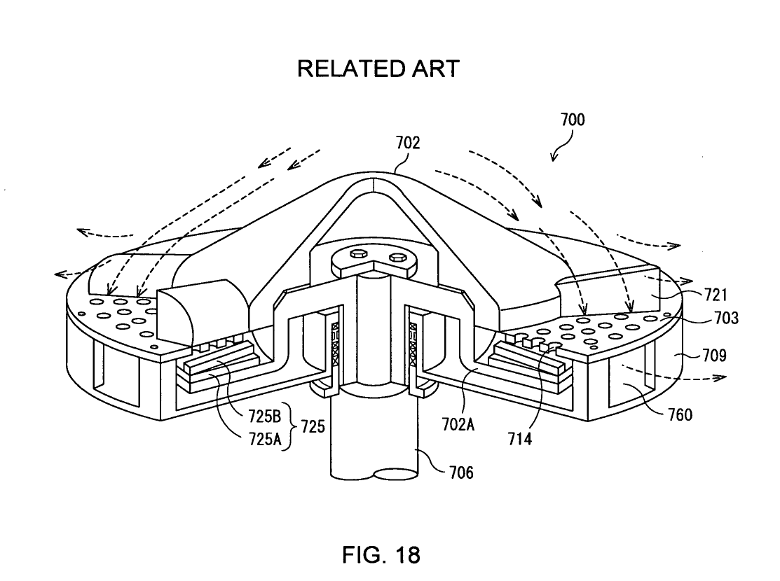

### DESCRIPTION OF THE PREFERRED EMBODIMENTS

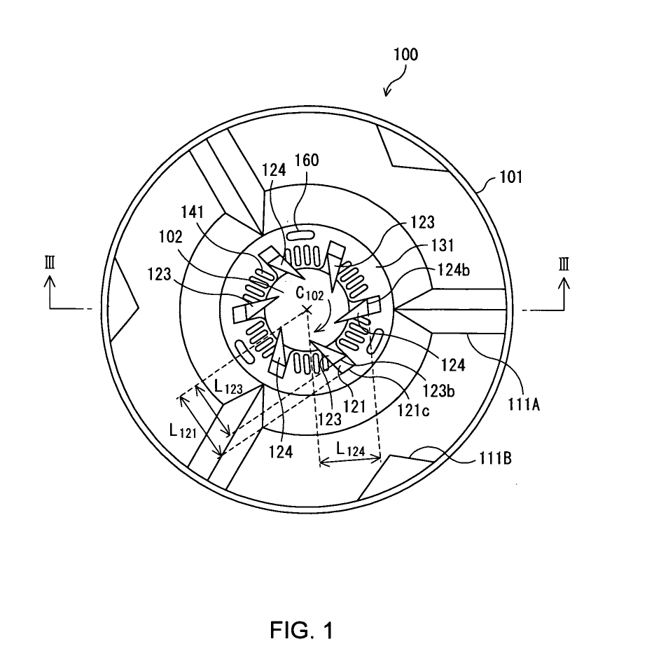

First of all, referring to FIGS. 1 to 10, a description will be given hereinbelow of a stock re-pulper 100 according to an embodiment of the present invention.

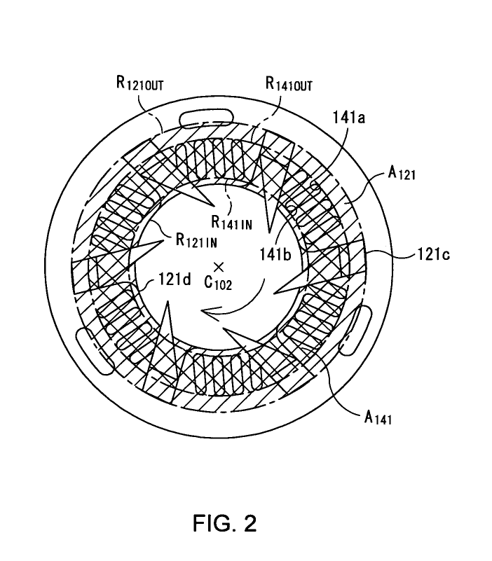

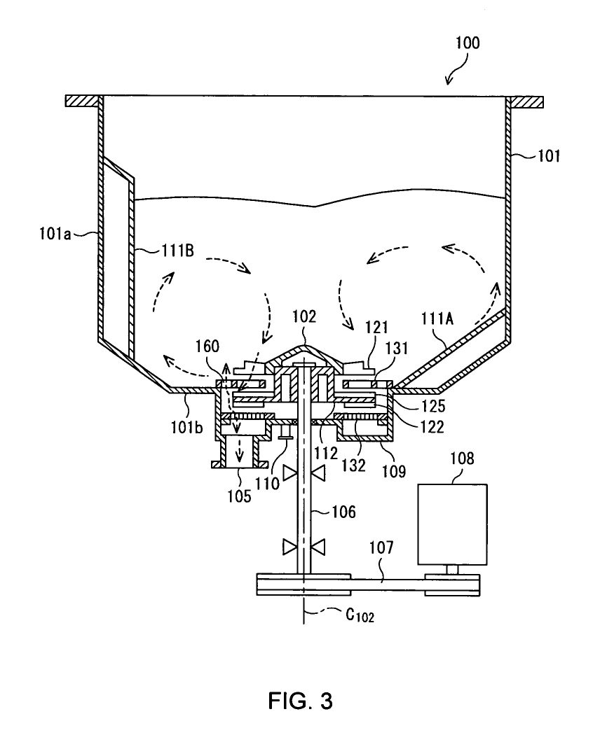

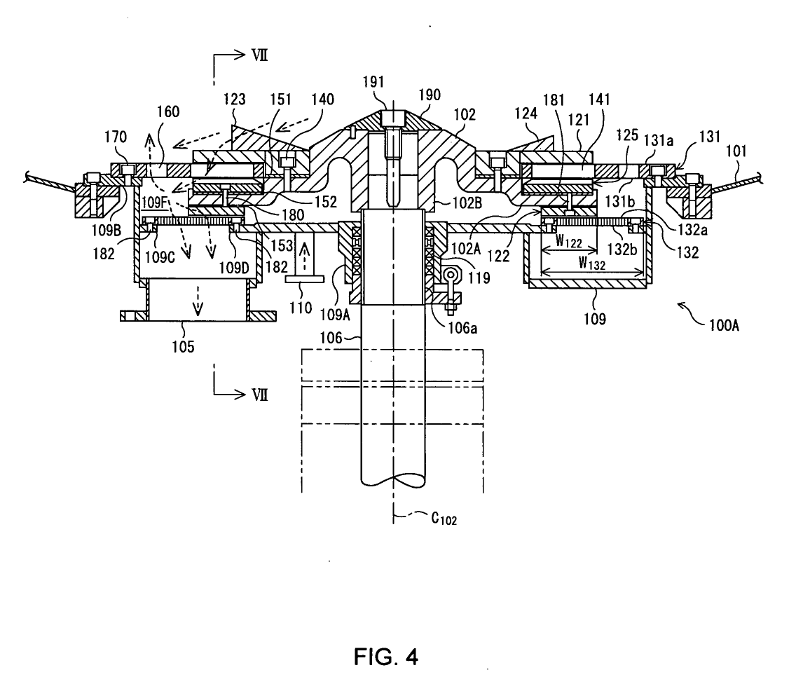

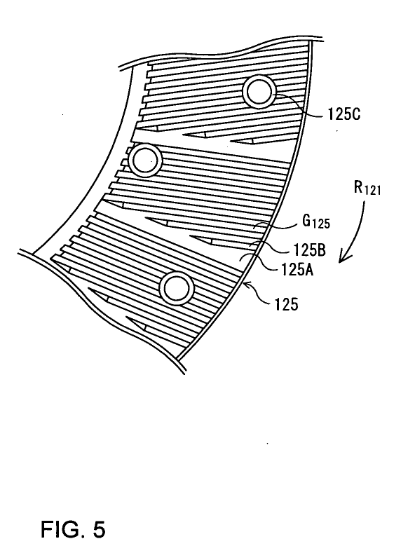

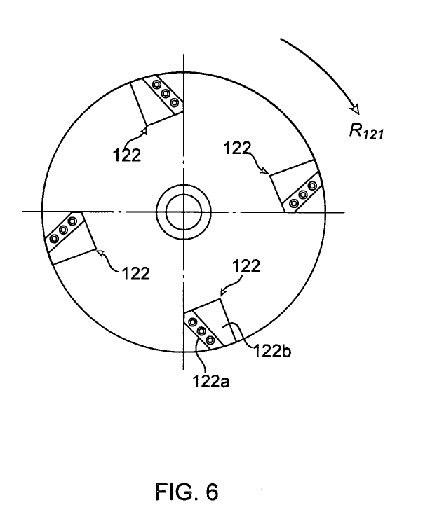

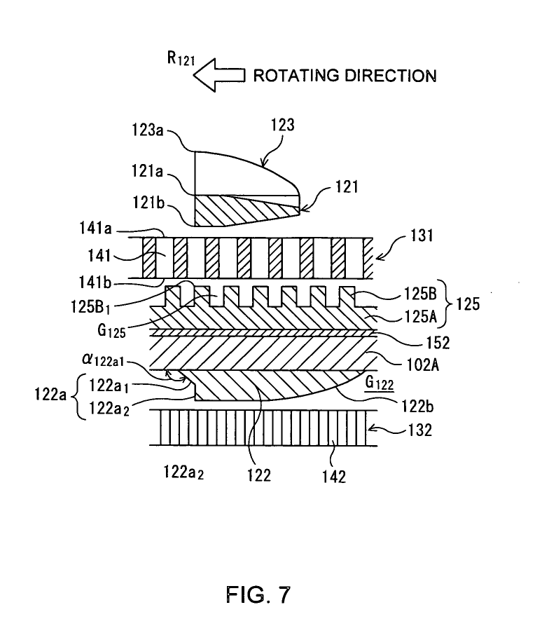

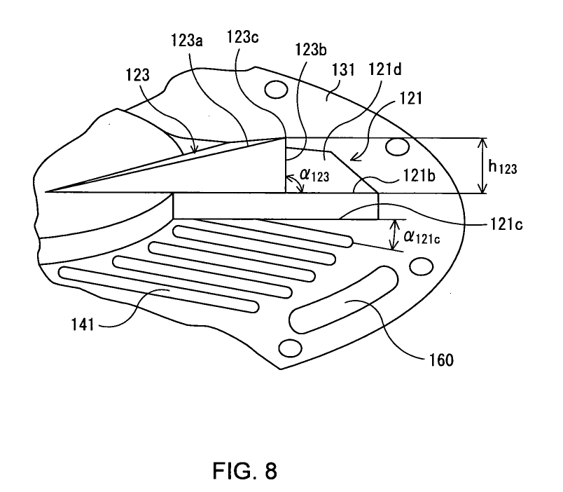

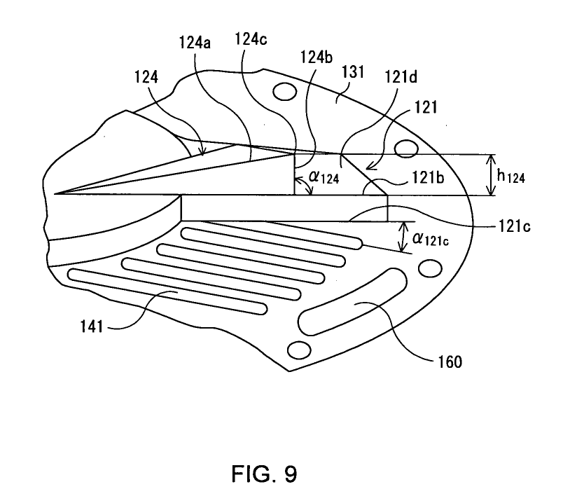

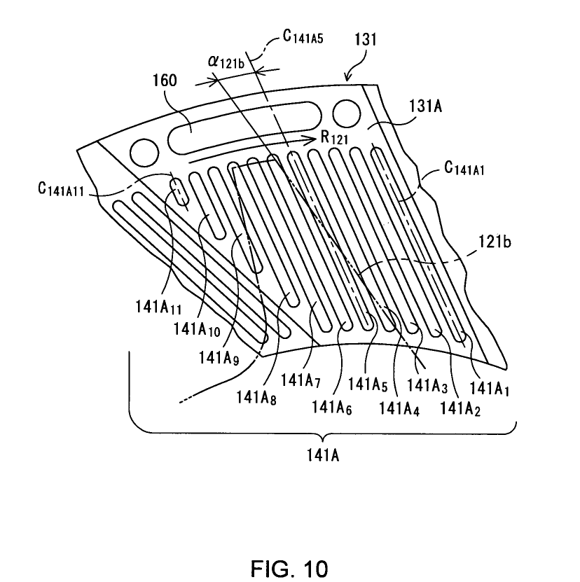

FIG. 1 is a top view illustratively showing the entire construction of the stock re-pulper 100 according to this embodiment, FIG. 2 is en enlarged view illustratively showing a central portion thereof, FIG. 3 is a cross-sectional view taken along arrows III-III of FIG. 1, FIG. 4 is a cross-sectional view illustratively a construction of an essential part of the stock re-pulper, FIG. 5 is a plan view illustratively showing a part of a pump blade, FIG. 6 is a plan view illustratively showing second macerating blades, FIG. 7 is an illustrative cross-sectional view taken along arrows VII-VII of FIG. 4, FIGS. 8 and 9 are perspective views illustratively showing a construction of an essential part thereof, and FIG. 10 is a plan view mainly showing a first hole-made plate (board). In the description, an essential part construction (marked with a reference numeral 100A) of the stock re-pulper 100 shown in FIG. 4 will sometimes be referred to hereinafter as an “agitation maceration unit”.

As shown in FIGS. 1 and 3, this stock re-pulper 100 is equipped with a stock tub 101 having a cylindrical configuration, and this tub 101 is made to accommodate water serving as a dilute solution and stock.

In addition, to a bottom portion 101b of the tub 101, there are fixedly secured a first porous plate (first hole-made plate) 131 and a chamber 109, and to this chamber 109, there is attached a second porous plate (second hole-made plate) 132.

In the chamber 109, an output pipe 105 is provided in order to discharge the stock, the maceration processing of which reached completion, to the external and a dilution waterspout 110 is provided to put water into the tub 101. These output pipe 105 and dilution waterspout 110 are openable and closable through the use of valves (not shown).

Still additionally, as shown in FIG. 4, a sleeve 109A, into which a rotary shaft 106 is to be inserted, is formed in a central portion of the chamber 109. The axis C₁₀₂ of the rotary shaft 106 coincides with the central axis of rotation of a rotor 102 to be mentioned later.

Yet additionally, in the chamber 109, a sorting unit 109F is a space formed between the first porous plate 131 and the second porous plate 132 and on the outer-circumferential side relative to a pump blade 125 and second macerating blades (second macerating blade unit) 122. The pump blade 125 and the second macerating blades 122 will be mentioned later.

Inside the tub 101, there are formed a turning plate 111A and a revolution preventing plate 111B.

The turning plate 111A is formed in a state inclined (obliquely) from a side portion 101a of the tub 101 to a bottom portion 101b thereof and in a state protruded toward the inside of the tub 101. The formation of this turning plate 111A enables turning a flow of stock in a circumferential direction (hereinafter referred to as a “revolving flow”) to a flow thereof in a longitudinal direction (hereinafter referred to as a “longitudinal flow”).

The revolution preventing plate 111B is formed at the side portion 101a of the tub 101 so as to extend in a longitudinal direction in a state protruded toward the inside of the tub 101, thereby preventing the occurrence of a revolving flow.

The first porous plate 131 is one ring-like plate having an opening at its central portion and is disposed horizontally and concentrically with respect to the axis C₁₀₂ forming an axis of rotation of the rotor 102. In addition, this first porous plate 131 has a plurality of elongated holes (first holes) 141 and a plurality of circulation openings 160, which are bored therein.

Moreover, as shown in FIG. 4, this first porous plate 131 is fixedly secured through bolts 170 to a drum portion 109b of the chamber 109 so as to cover the chamber from the above. Still moreover, first macerating blades (first macerating blade unit) 121, which will be mentioned later, are rotated in proximity to an upper surface (one surface) 131a of the first porous plate 131 while a pump blade 152, mentioned later, is rotated in close vicinity to a lower surface (the other surface) 131b of the first porous plate 131.

Still moreover, as shown in FIG. 10, the first holes 141 are made to be 11 in number for each segment. In FIG. 10, there are exemplified one segment 131A of the porous plate 131 divided virtually into 16 segments. Yet moreover, in FIG. 10, a two-dot chain line depicts a front lower edge 121b of each of the first macerating blades 121, and this first macerating blades 121 are designed to be clockwise rotated around the axis C₁₀₂ of the rotor 102 as indicated by an arrow R₁₂₁.

Incidentally, in FIG. 10, the angle indicated by a reference mark α_{121b} is an angle made between a major axis C₁₄₁ of the first hole 141A and the front lower edge 121b of each of the first macerating blade 121. For convenience only, FIG. 10 shows only an angle made between the major axis C_{141A5} of the first hole 141A5, which is fifth in order from the right, and the front lower edge 121b of each of the first macerating blades 121.

In the segment 131A shown in FIG. 10, the first hole 141A₁ formed on the rightmost side is made such that the angle α_{121b} made between the major axis C_{141A1} of the first hole 141A₁ and the front lower edge 121b of each of the first macerating blades 121 is slightly larger than zero degree (for example, α_{121b}≈1°) in a state where the front lower edge 121b of each of the first macerating blades 121 crosses the first hole 141A₁.

On the other hand, the other first holes 141A₂ to 141A₁₁ are made such that their major axes are parallel with the major axis C_{141A1} of the aforesaid rightmost first hole 141A₁.

In addition, in the segment 131A shown in FIG. 10, the angle α_{121b} made between the major axis C_{141A11} of the first hole 141A₁₁, positioned on the leftmost side, and the front lower edge 121b of each of the first macerating blades 121 is approximately 20 degrees.

That is, in the segment 131A, the angle α_{121b} is in a range from approximately 1° to approximately 20° and increases gradually from the first hole 141A₁ formed on the rightmost side toward the first hole 141A₁₁ formed on the leftmost side.

Owing to such formation of the respective first holes 141A₁ to 141A₁₁, at the rotation of the first macerating blades 121, the front lower edge 121b of each of the first macerating blades 121 cuts through the respective first holes 141A₁ to 141A₁₁ while intersecting obliquely with them so that the first macerating blades 121 and each of the first holes 141A₁ to 141A₁₁ are in cooperation with each other like two edges of scissors.

Moreover, a result of the study by the inventor shows that, as practicable, the hole width of each of the first holes 141A₁ to 141A₁₁ is properly changeable in a range from approximately 3 mm to approximately 40 mm and the hole length of each of the first holes 141A₁ to 141A₁₁ is properly changeable in a range from approximately 3 mm to approximately 25 mm. Still moreover, another result of the study by the inventor shows that, preferably for practical use, the ratio of the opening area of the first holes 141 (i.e., the rate of open area of the first porous plate) to the area where the first holes 141 are physically formable in the first porous plate 131 is approximately 10 to 50%.

In this connection, since the stock maceration efficiency further improves as the number of first holes 141 increases, it is desirable that the number of the first holes 141 is as large as possible in the range where the rate of open area of the first porous plate is agreeable.

At the center of the first porous plate 131, the rotor 102 is disposed to be rotatable around the axis C₁₀₂ relative to the first porous plate 131.

In addition, this rotor 102 is connected through the rotary shaft 106 and a V belt 107 to a motor (drive source) 108 and, in response to the driving of the motor 108, the rotor 102 is rotated around the axis C₁₀₂. This motor 108 is provided with a control switch (not shown) so that an operator can on/off-control the motor 108 through the use of this control switch.

Still additionally, a sleeve 106a of the rotary shaft 106 is supported by a sleeve 109a of the chamber 109 through a solution leakage preventing seal 119 to be relatively rotatable.

Yet additionally, a rotor sleeve 102B for supporting a flange 102A of the rotor 102 is inserted into a tip portion of the rotary shaft 106, and the rotor 102 and the rotary shaft 106 are fixed through a cover 190, mounted on a top portion of the rotor 102, to each other by means of a bolt 191.

As FIG. 4 shows, the flange 102A is made to extend from the axis C₁₀₂ side of the rotor 102 toward an outer-circumferential side of a lower surface of the first porous plate 131. Moreover, each of the first macerating blades 121 is fixed by a bolt 140 on the axis C₁₀₂ side of the flange 102A. Incidentally, although in this embodiment the first macerating blades 121 are six in number, the present invention is not limited to this but the number thereof can be properly changed in a range from 3 to 16.

Furthermore, a shim 151 is interposed between the first macerating blades 121 and the flange 102A so that the distance between the first macerating blades 121 and the first porous plate 131 can be properly changed by changing the thickness of this shim 151 or by changing the number of shims 151. In this connection, a result of the study by the inventor indicates that a high maceration effectiveness is attainable when the distance between the first macerating blades 121 and the first porous plate 131 is set at approximately 0.5 to 5 mm.

With reference to FIG. 2, a description will be given hereinbelow of a rotating area A₁₂₁ of the first macerating blades 121 and a first porous area A₁₄₁ of the first porous plate 131.

Of these, the rotating area A₁₂₁ of the first macerating blades 121 is defined as an area surrounded by an outer circle R_{121OUT} having a radius from the axis C₁₀₂ of the rotor 102 to an outer-circumferential end 121c of the first macerating blades 121 at the center of the axis C₁₀₂ and an inner circle R_{121IN} having a radius from the axis C₁₀₂ to an inner-circumferential end 121d of the first macerating blades 121 at the center of the axis C₁₀₂.

On the other hand, the first porous area A₁₄₁ of the first porous plate 131 is defined as an area surrounded by an outer circle R_{141OUT} having a radius forming a distance from the axis C₁₀₂ to an outer-circumferential end 141a of the first holes 141 at the center of the axis C₁₀₂ and an inner circle R_{141IN} having a radius forming a distance from the axis C₁₀₂ to an inner-circumferential end 141b of the first holes 141 at the center of the axis C₁₀₂.

That is, the rotating area A₁₂₁ of the first macerating blades 121 includes the entire first porous area A₁₄₁ of the first porous plate 131.

In other words, when the rotor 102 rotates at the center of the axis C₁₀₂, regardless of its angle of rotation, any one of the six first macerating blades 121 intersects with one of the first holes 141 at all times.

As FIG. 1 shows, third macerating blades (third macerating blade unit) 123 and fourth macerating blades (fourth macerating blade unit) 124 are alternately disposed above the six first macerating blades 121.

Of these, the third macerating blades 123 have a triangular pyramid configuration as shown in FIGS. 1 and 8, and a distance L₁₂₃ from the axis C₁₀₂ to an outer edge portion 123b of the third macerating blades 123 is set to be shorter than a distance L₁₂₁ from the axis C₁₀₂ to an outer-circumferential end 121c of the first macerating blades 121.

In addition, each of the third macerating blades 123 is formed such that the angle α₁₂₃ made between the outer edge portion 123b thereof and an upper surface portion 121d of each of the first macerating blades 121 becomes a right angle. A result of the study by the inventor shows that, in a case in which the angle α₁₂₃ made between the outer edge portion 123b of each of the third macerating blades 123 and the upper surface portion 121d of each of the first macerating blades 121 is set at a right angle or acute angle, the stock maceration efficiency is improvable.

Each of the fourth macerating blades 124 has a triangular pyramid configuration as shown in FIGS. 1 and 9, and a distance L₁₂₄ from the axis C₁₀₂ to an outer edge portion 124b thereof is set to be shorter than the distance L₁₂₁ from the axis C₁₀₂ to the outer-circumferential end 121c of the first macerating blades 121. Moreover, the height h₁₂₄ of each of the fourth macerating blades 124 is set to be lower than the height h₁₂₃ of each of the third macerating blades 123.

Still additionally, each of the fourth macerating blades 123 is formed such that an angle α₁₂₄ made between the outer edge portion 124b thereof and the upper surface portion 121d of each of the first macerating blades 121 becomes a right angle. In this connection, a result of the study by the inventor shows that, even when the angle α₁₂₄ made between the outer edge portion 124b of each of the fourth macerating blades 123 and the upper surface portion 121d of each of the first macerating blades 121 is set at an acute angle without being set at a right angle, the stock maceration efficiency is also improvable.

On an upper surface of the flange 102A, a ring-like pump blade 125 positioned at the center of the axis C₁₀₂ is fixed through the use of bolts 180 so that the first porous plate 131 is interposed between the first macerating blades 121 and the pump blade 125.

Moreover, a shim 152 is interposed between the flange 102A and the pump blade 125, and the distance between the first porous plate 131 and the pump blade 125 is adjustable properly by changing the thickness of this shim 152. According to the study by the inventor, when the distance between the first porous plate 131 and the pump blade 125 is set to be approximately 0.5 to 5 mm, a high maceration effectiveness is obtainable.

Incidentally, in addition to producing the stock maceration effectiveness in cooperation with the first porous plate 131, the pump blade 125 creates an effectiveness to put the stock within the tub 101 through the first porous plate 131 into circulation in a positive manner.

As shown in FIGS. 5 and 7, this pump blade 125 is made up of a ring-like base portion 125A and a plurality of blade portions 125B formed at a given interval on an upper surface of the base portion 125A.

Of these, the base portion 125A is formed to have a ring-like configuration when viewed from the above and, as shown in FIG. 5, the blade portions 125B are formed radially and linearly on the base portion 125A at the substantial center of the axis C₁₀₂, and they are arranged at a given interval. For example, these blade portions 125B can be formed into a circular arc configuration having a relatively large radius.

These blade portions 125B are formed on the base portion 125A to occupy an area including the first porous area A₁₄₁. In this pump blade 125, there are made bolt holes 125C into which the bolts 180 are inserted in order to make a connection between the flange 102A and the pump blade 125.

As shown in FIG. 4, as well as the first porous plate 131, the second porous plate 132 is a ring-like plate having an opening in its central portion at the center of the axis C₁₀₂, and a plurality of round holes (second holes) 142 (see FIG. 7) each having a generally complete round configuration are made therein.

Moreover, this second porous plate 132 is disposed above the output pipe 105 and fixedly secured through bolts 182, 182 to seating 109C and 109D formed in the interior of the chamber 109. Still moreover, the second macerating blades 122, mentioned later, are rotated in a state close to an upper surface (one surface) 132a of this second porous plate 132.

According to the study by the inventor, as practicable, preferably, the diameter of each of the second holes 142 is set to be in a range from approximately 0.15 mm to approximately 16 mm and, preferably, the rate of open area of the second porous plate 132 is set to be in a range from approximately 10% to approximately 50%. Moreover, since the maceration efficiency improves in proportion to the number of second holes 142, it is desirable that the number of second holes 142 becomes larger, provided that the rate of open area is in a preferable range.

As shown in FIG. 4, the second macerating blades 122 are fixedly secured through bolts 181 to a lower surface of the flange 102A of the rotor 102. In this embodiment, the second macerating blades 122 are four in number as shown in FIG. 6. Incidentally, it was found that the number of second macerating blades 122 is not limited to four but, as practicable, the number of second macerating blades 122 is properly changeable in a range from 3 to 8 and, more preferably, 3 to 6.

In addition, a shim 153 is interposed between the second macerating blades 122 and the flange 102A, and the distance between the second macerating blades 122 and the second porous plate 132 is properly changeable by changing the thickness of the shim 153 or by changing the number thereof. According to the study by the inventor, when the distance between the second macerating blades 122 and the second porous plate 132 is set to be approximately 0.5 mm to approximately 5 mm, a high maceration effectiveness is attainable.

Still additionally, as shown in FIG. 7, a front surface 122a of each of the second macerating blades 122 is composed of a surface (inclined plane) 122ₐ₁ inclined by an angle α₁₂₂ₐ₁ with respect to the flange 102A and a wall surface (upstanding plane) 122ₐ₂ formed so as to make a right angle with respect to the flange 102A.

That is, the formation of the inclined plane 122ₐ₁ is for reducing the flow resistance occurring at the rotation of the second macerating blades 122 and the formation of the upstanding plane 122ₐ₂ is for preventing the reduction of the maceration effectiveness due to the second macerating blades 122.

Moreover, a lower surface of each of the second macerating blades 122 is formed as an inclined plane whose height from the flange 102A decreases toward the downstream side and is formed such that the gap relative to the second porous plate 132 becomes gradually wider toward the downstream side, which generates a negative pressure between the lower surface 122b and the second porous plate 132, thereby preventing the stock from getting jammed in the second holes 142 made in the second porous plate 132.

Furthermore, as FIG. 4 shows, a radial distance W₁₂₂ of the second macerating blades 122 is set to be shorter than a radial distance W₁₃₂ of the second porous plate 132, thereby exhibiting a high maceration effectiveness and reducing the drive torque of the motor 108 needed for the rotation of the rotor 102.

The stock re-pulper 100 according to this embodiment is constructed as described above and an operation of this stock re-pulper 100 produces the following effects and provides various effectiveness.

First, the operation of the motor 108 takes place when an operator turns on a control switch (not shown) and the power is transmitted from the motor 108 to the rotary shaft 106 to rotate the rotor 102 so that the first macerating blades 121 and the pump blade 125 are rotated around the axis C₁₀₂.

At this time, the first macerating blades 121 are rotated in proximity to the upper surface 131a of the first porous plate 131, and the pump blade 125 is rotated in proximity to the lower surface 131b of the first porous plate 131.

In addition, the third macerating blades 123 and the fourth macerating blades 124, alternately formed, are also rotated around the axis C₁₀₂ due to the rotation of the rotor 102 at the upper surfaces 121d of the six first macerating blades 121, thus agitating the stock within the tub 101 in a good condition.

Still additionally, with the rotation of the rotor 102 (see an arrow R₁₂₁ in FIG. 7) , the front upper edges 121a of the first macerating blades 121 and the front upper edges 123a of the third macerating blades 123 efficiently lacerate the stock within the tub 101. In particular, the top portions (outer edge upper ends) 123c of the third macerating blades 123 and the top portions (outer edge upper ends) 124c of the fourth macerating blades 124 have a pointed configuration, thereby sharply lacerating the stock within the tub 101.

Incidentally, although the rotation of the first macerating blades 121, the third macerating blades 123 and the fourth macerating blades 124 produces a revolution flow of the stock in the tub 101, the formation of the turning plate 111A and the revolution preventing plate 111B within the tub 101 turns this revolution flow to a longitudinal flow so that the stock circulates in the interior of the tub 101.

On the other hand, with the rotation of the rotor 102, the pump blade 125 is also rotated around the axis C₁₀₂, thus applying a centrifugal force to the stock. In consequence, the stock existing in the chamber 109 (in more detail, a groove portions G₁₂₅ defined between the blade portions 125B of the pump blade 125) is shifted forcibly toward an outer circumference thereof and the pressure in the groove portions G₁₂₅ of the pump blade 125 drops. Moreover, the stock within the tub 101 is forcibly introduced through the plurality of first holes 141 of the first porous plate 131 formed above the revolution area of the pump blade 125 into the groove portions G₁₂₅ of the pump blade 125 where the pressure drops.

In this connection, the function of forcibly putting the stock in the tub 101 into the chamber 109 through the rotation of the pump blade 125 is referred to as a “suction function” and, as shown in FIG. 7, the stock sucked through the first holes 141 of the first porous plate 131 into the chamber 109 owing to this suction function is lacerated between the front lower edges 121b of the first macerating blades 121 and the upper edges 141a of the first holes 141 and, following this, it is further lacerated between the lower edges 141b of the first holes 141 and the front upper edges 125B₁ of the pump blade 125.

In addition, the stock sent to the sorting unit 109F of the chamber 109 then flows downwardly by the function of force of gravity and tends to flow further downwardly through the plurality of round holes 142 made in the second porous plate 132.

Meanwhile, since the inner diameter of each of the round holes 142 is made to be smaller than the inner diameter of each of the first holes 141 formed in the first porous plate 131, the stock (hereinafter referred to as “semi-macerated stock”) macerated to the extent that it can pass through the first holes 141 but non-macerated to the extent that it can pass through the second holes 142 collects on the upper surface 132a of the second porous plate 132 while only the stock sufficiently macerated into fine sizes passes through the round holes 142 and is discharged as macerated stock through the output pipe 105.

Moreover, a portion of the stock sent out into the sorting unit 109F of the chamber 109 flows between the second macerating blades 122, which are in rotation, and the second porous plate 132 to be lacerated between the second macerating blades 122 and the second porous plate 132 and, as a result, the stock having minute sizes passes through the round holes 142 of the second porous plate 132 and is discharged as the macerated stock through the output pipe 105.

Incidentally, in addition to the promotion of the stock maceration, the rotation of the second macerating blades 122 can prevent the stock from being left on the second porous plate 132. That is, the plurality of round holes formed in the second porous plate 132 have a small diameter and, hence, the stock which cannot pass through the round holes 142 remains on the second porous plate 132. However, in the stock re-pulper 100 according to this embodiment, the rotation of the second macerating blades 122 around the axis C₁₀₂ removes the stock left on the second porous plate 132 and, following this, the centrifugal force delivers this stock to an outer circumferential side in the sorting unit 109F in the interior of the chamber 109.

In addition, since the radial distance W₁₂₂ of the second macerating blades 122 is set to be shorter than the radial distance (see reference mark W₁₃₂ in FIG. 4) of the second porous plate 132 as shown in FIG. 4, although it is apparently considered that the semi-macerated stock remains on the upper surface 122a of the second porous plate 132 in the area through which the second macerating blades 122 pass, in fact such an event does not occur. This because, when the second macerating blades 122 are put into rotation and the left stock gathered by the inclined planes 122a formed on the front surfaces of the second macerating blades 122 is then sent to the outer-circumferential side of the sorting unit 109F of the chamber by the centrifugal force, the semi-macerated stock which has not been gathered directly by the second macerating blades 122 is collectively sent to the outer-circumferential side of the sorting unit 109F.

Incidentally, although it is also acceptable that the radial distance W₁₂₂ of the second macerating blades 122 is set to be equal to the radial distance W₁₃₂ of the second porous plate 132, in a case in which the radial distance W₁₂₂ of the second macerating blades 122 is set to be shorter than the radial distance W₁₃₂ of the second porous plate 132 as employed in this embodiment, the power needed for the rotation of the second macerating blades 122, i.e., the drive torque required for the motor 108 to rotate the rotor 102, is reducible and, hence, the structure according to this embodiment is more preferable in light of the energy saving.

On the other hand, the semi-macerated stock which cannot pass through the round holes 142 of the second porous plate 132 is again returned through the circulation openings 160, bored in the outer-circumferential side of the first porous plate 131, to the tub 101.

That is, although the semi-macerated stock temporarily resides at the sorting unit 109F of the chamber 109, the pressure in the sorting unit 109F occurring due to the rotations of the pump blade 125 and the second macerating blades 122 sends the semi-macerated stock from the sorting unit 109F through the circulation openings 160 formed in the first porous plate 131 to the interior of the tub 101.

Thus, with the stock re-pulper 100 according to this embodiment, the stock put together with the dilute solution into the tub 101 can be guided actively between the first macerating blades 121, which is in rotation, and the first porous plate 131 (to a first working section) and it can further be guided actively between the first porous plate 131 and the pump blade 125 which is in rotation (to a second working section) and it can still moreover be guided between the second macerating blades 122, which are in rotation, and the second porous plate 132 (to a third working section), thereby providing a high maceration effectiveness on the stock while suppressing the required drive torque from the motor 108.

Furthermore, since the third macerating blades 123 and the fourth macerating blades 124 are alternately disposed on the plurality of first macerating blades 121, it is possible to agitate the stock, put together with the dilute solution into the tub 101, in a better condition, and since the third macerating blades 123 and the fourth macerating blades 124, which are in rotation, can lacerate the stock in a good condition, the maceration processing efficiency is improvable.

Still furthermore, since the third macerating blades 123 and the fourth macerating blades 124 are formed on the first macerating blades 121, even in a case in which the height of the first macerating blades 121 is set at a low value, a sufficient maceration effectiveness is attainable, and in this case, the required drive torque from the motor 108 for rotating the rotor 102 is suppressible, which contributes to the energy saving.

Yet furthermore, since the third macerating blades 123 and the fourth macerating blades 124 can agitate and lacerate the stock sucked from the tub 101 through the first holes 141 into the chamber 109 owing to the suction function stemming from the rotation of the pump blade 125, the stock maceration efficiency is provable without increasing the rotational speed of the rotor 102, which can further contribute to the energy saving.

Moreover, since the second macerating blades (blade portions) 122 are formed such that the gaps relative to the second porous plate 132 become gradually larger toward the downstream side, the generation of a negative pressure between the blade portions 122 and the second porous plate 132 becomes feasible, which can prevent the stock from getting jammed in the second porous plate 132.

Still moreover, since the second holes 142 are formed to have an open area smaller than the open area of the first holes 141, only the stock undergoing the rough maceration processing up to the extent that it can pass through the first holes 141 reaches the second porous plate 132 and, following this, only the stock undergoing the fine maceration processing up to the extent that it can pass through the second holes 142 is discharged as the macerated stock through the output pipe 105 to the external.

Yet furthermore, since each of the first holes 141 is formed as an elongated hole extending in a generally radial direction of the first porous plate 131 and the longitudinal axis (major axis) C₁₄₁ thereof is set to be inclined with respect to the first macerating blades 121 in a range between a value larger than 0 degree and a value not more than 20 degrees, the first macerating blades 121 being in rotation can cut through the first holes 141 in a state of intersecting obliquely. That is, this makes a cooperation between the first macerating blades 121 and the first holes 141 forming elongated holes, like two edges of scissors, which enables the stock to be lacerated by a large force between the first macerating blades 121 and the first holes 141 (at the first working section) thereby enhancing the maceration efficiency.

In addition, the formation of the plurality of second macerating blades 122 can enhance the maceration processing efficiency.

Still additionally, the formation of each of the groove portions G₁₂₂between the plurality of second macerating blades 122 enables the generation of a negative pressure at the groove portions G₁₂₂, which prevents the stock from being getting jammed in the second holes 142 made in the second porous plate 132, and the semi-macerated stock deposited on the second porous plate 132 without passing through the second holes 142 can be blown away through the groove portions G₁₂₂ toward the outer-circumferential side of the sorting unit 109F.

Yet additionally, the hole width W₁₄₁ of each of the first holes 141 is set at a value in a range from 3 mm to 40 mm and the hole width W₁₄₂ of each of the second holes 142 is set at a value in a range from 0.15 mm to 16 mm and the rates of open areas of the first and second porous plates 131 and 132 are set at a value in a range from 10% to 50%, which provides a high maceration efficiency while maintaining the required rigidity of each of the first and second porous plates 131 and 132.

Moreover, each of the angles α123 and α124 made between the outer edge portions 123b, 124b of the third and fourth macerating blades 123, 124 and the upper surface portions 121A of the first macerating blades 121 is set at a right angle or acute angle, which enables the outer edge upper end portions 123b and 124b of the third and fourth macerating blades 123 and 124 to be formed into pointed configurations, thus lacerating the stock in a good condition so as to conduct efficient maceration processing.

Still moreover, with respect to the second porous plate 132, there is provided the output pipe 105 disposed on the lower surfaces 122b side of the second macerating blades 122 for discharging the stock (i.e., macerated stock), after passing through the second holes 142, to the external. The formation of the output pipe 105 enables the macerated stock to be promptly discharged to the external for sending it to the next process.

Yet moreover, in the first porous plate 131, there are provided the circulation openings 160 bored in the outer-circumferential side with respect to the first porous area A₁₄₁ for making a communication between the first porous plate 131 and the tub 101. The formation of the circulation openings 160 enables the stock (i.e., semi-macerated stock), macerated to the extent that it can pass through the first holes 141 but non-macerated to the extent that it can pass through the second holes 142, to be returned to the tub 101, which enables the maceration processing in a continuous running fashion.

In addition, it is possible to concentrate the stock, returned through the circulation openings 160 into the tub 101, on the first macerating blades 121, the third macerating blades 123 and the fourth macerating blades 124, which can provide a high maceration efficiency even in the case of the implementation of the maceration processing in a continuous running fashion.

The present invention is not limited to the above-described embodiment. A description will be given hereinbelow of some modifications thereof.

The same components as those in the above-described embodiment are marked with the same reference numerals, and the description will be given with emphasis on the differences from the embodiment. The drawings used for the description of the embodiment will sometimes be put to use.

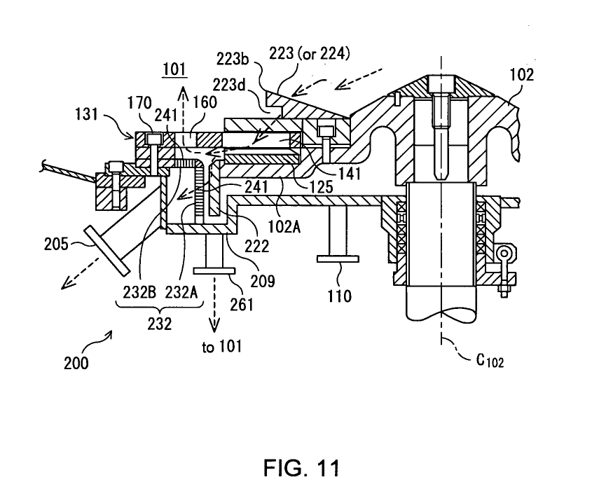

FIG. 11 is a cross-sectional view illustratively showing an essential part of a stock re-pulper 200 producing a modification of the stock re-pulper 100 according to the above-described embodiment.

In FIG. 11, characteristic components are third macerating blades 223, second porous plate 232 and second macerating blades 222. The description of the third macerating blades 223 also applies to that of fourth macerating blades 224 and, therefore, as an example, the description will be given here of only the third macerating blades 223.

A difference of the third macerating blades 223 according to this modification from the third macerating blades 123 (see FIG. 4) according to the above-described embodiment is that a notch portion 223d is formed in a portion of an outer edge portion 123b of each of the third macerating blades 223.

That is, the formation of the notch portion 223d in each of the third macerating blades 223 can reduce its front projective area, which leads to enhancing the stock maceration effectiveness while reducing the required drive torque from the motor 108 for the rotation of the rotor 102.

In addition, a difference of the second porous plate 232 according to this modification from the second porous plate 132 (see FIG. 4) according to the above-described embodiment is that it is formed into a cylindrical configuration in which the axis C₁₀₂ is set as its longitudinal central axis and formed such that its upper end portion extends horizontally in an outer-circumferential direction. That is, the second porous plate 232 is composed of a portion (cylindrical wall surface portion) 232A formed as a wall surface of a cylindrical configuration and a portion (horizontal portion) 232B extending horizontally.

Still additionally, in the second porous plate 232, the horizontal portion 232B, together with the first porous plate 131, is fixedly secured through bolts 170 to a chamber 209.

Yet additionally, a plurality of second holes 241 are bored in each of the cylindrical wall surface portion 232A and the horizontal portion 232B. These second holes 241 are formed as generally complete round holes as well as the above-described embodiment.

Moreover, as a difference from the second macerating blades 122 (see FIG. 4) according to the above-described embodiment, each of the second macerating blades 222 extending vertically is fixed to an outer-circumferential end portion of the flange 102A and is rotated inside the cylindrical second porous plate 232 and in proximity to an inner surface of the cylindrical second porous plate 232.

Still moreover, inside the cylindrical second porous plate 232 and under the second macerating blades 222, a circulation pipe 261 is provided which makes a communication between the tub 101 and the interior of the chamber 209. Yet moreover, an output pipe 205 is located on an outer-circumferential side of the chamber 209 to discharge, to the external, the stock after passing through the second holes 241.

Furthermore, in the construction shown in FIG. 11, in accordance with the rotation of the rotor 102, the stock in the tub 101 is agitated by the first macerating blades 121, the third macerating blades 123 and the fourth macerating blades 124 and is macerated between the first macerating blades 121 and the first porous plate 131. Following this, the stock reaches the lower surface of the first porous plate 131 through the first holes 141, where the stock is lacerated between the first porous plate 131 and the pump blade 125 so that the maceration further advances, and it is delivered to the outer-circumferential side of the pump blade 125.

Thereafter, this stock flows into the gap between the second macerating blades 222 and the second porous plate 232 to be lacerated therebetween, thereby further conducting the maceration processing to further break the stock up.

Still furthermore, the stock undergoing the maceration processing so that its sizes become smaller than the hole diameters of the second holes 241 formed in the second porous plate 232 is discharged through the output pipe 205 to the external after passing through the second holes 241. On the other hand, the stock having sizes larger than the hole diameters of the second holes 241 is returned through the circulation openings 160 to the tub 101 or is returned to the tub 101 through the circulation pipe 261 disposed inside the cylindrical second porous plate 232 and under the second macerating blades 222.

As described above, with the stock re-pulper 200 according to the modification shown in FIG. 11, a centrifugal force can be applied to the stock undergoing the maceration processing between the second macerating blades 222 and the second porous plate 232 so that more stock is guided directly to the cylindrical second porous plate 232. This can improve the maceration efficiency considerably.

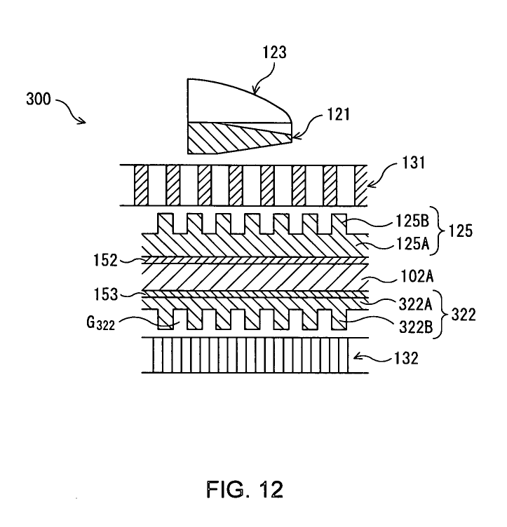

FIG. 12 is a cross-sectional view illustratively showing an essential part of a stock re-pulper 300 producing a further modification of the stock re-pulper 100 according to the above-described embodiment. In FIG. 12, the first macerating blades 121, the third macerating blades 123, the first porous plate 131, the base portion 125A and blade portions 125B of the pump blade 125, the flange 102A and the second porous plate 132 are the same as those described with reference to FIG. 7 and other illustrations, and the description thereof will be omitted for brevity.

That is, in the stock re-pulper 100 according to the modification shown in FIG. 12, a characteristic component is a second macerating blade 322. This second macerating blade 322 is made up of a ring-like base portion 322A and a plurality of blade portions 322B formed at a given interval on a lower surface of the base portion 322A.

Of these, the base portion 322A is formed into a ring-like configuration when viewed from the above, while the blade portions 322B are formed radially and linearly at the substantial center of the axis C₁₀₂ on the lower surface of the base portion 322A and arranged at a given interval. For example, these blade portions 322B can be formed into a circular arc configuration having a relatively large radius. Moreover, a groove portion(s) G₃₂₂ is defined between the plurality of blade portions 322B and 322B.

This construction enables considerably increasing the number of second macerating blades 322, which improves the maceration efficiency and efficiently blows away the semi-macerated stock accumulated on the upper surface of the second porous plate 132.

For a further understanding of the present invention, a description will be given hereinbelow of modifications other than the constructions shown in FIGS. 1 to 12 as an embodiment and modifications thereof.

For example, although in the above description of the embodiment 11 elongated holes 141 are formed in one segment 131A of the first porous plate 131, the present invention is not limited to this number of elongated holes 141, but the number of elongated holes 141 can properly be increased/decreased according to amount or kind of stock to be macerated.

In addition, although in the above description of the embodiment the first porous plate 131 is one ring-like plate, the present invention is not limited to this structure, but it is also appropriate that the first porous plate 131 is divided according to segment and, when fixed to the chamber 109, the divided sections are formed into a ring-like configuration at the center of the axis C₁₀₂.

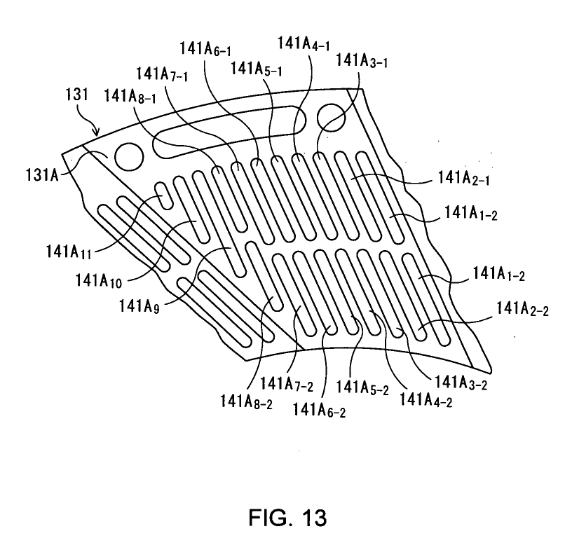

Still additionally, although in the above description of the embodiment all the elongated holes 141A₁ to 141A₁₁ are formed as one elongated hole, the present invention is not limited to this. That is, it is also acceptable that, as shown in FIG. 13, the respective elongated holes 141A₁ to 141A₈ (see FIG. 10) are divided into two: outer-circumferential side elongated holes 141A₁₋₁ to 141A₈₋₁ and inner-circumferential side elongated holes 141A₁₋₂ to 141A₈₋₂. This can enhance the rigidity of the first porous plate 131.

Yet additionally, although in the above description of the embodiment each of the first holes 141 is formed as an elongated hole, the present invention is not limited to this. However, as mentioned in detail with reference to FIG. 10, when the first holes 141 are made as elongated holes, there is a merit in that the so-called scissors effects are obtainable.

Moreover, although in the above description of the embodiment each of the second holes 142 is formed as a round hole, the present invention is not limited to this. For example, it is also appropriate that the second hole 142 is formed as an elongated hole extending in a substantially radial direction of the second porous plate 132 and the long axis (longitudinal axis) thereof is inclined in a range from larger than 0 degree to not larger than 20 degrees with respect to the second macerating blades 122.

This enables the second macerating blades 122 which are in rotation to intersect obliquely with the second holes 142 and, in other words, makes the second macerating blades 122 and the second holes 142, which are elongated holes, cooperate with each other like two edges of scissors, so the stock can be lacerated by large force between the second macerating blades 122 and the second holes 142 (second working section) which improves the maceration efficiency.

Furthermore, although the edge portions of the first to fourth macerating blades 121, 122, 123 and 124 and the pump blade 125 are gradually worn away, as the countermeasures against this abrasion, it is also appropriate that a replacement blade made of a material having a high abrasion resistance is mounted on a front surface of each of these blades 121, 122, 123 and 124.

The blade dispositions of the first to fourth macerating blades 121, 122, 123 and 124 and the pump blade 125 and the disposition intervals (pitches) and configurations thereof are not limited to those mentioned above, but various changes and modifications are possible.

Still furthermore, although in the above description of the embodiment the stock re-pulper 100 is equipped with the agitation and maceration unit 100A (see FIG. 4) on a bottom portion of the open type tub 101, the present invention is also applicable to a stock re-pulper equipped with a hermetically sealed type tub or a stock re-pulper in which the agitation and maceration unit 100A is provided on a side surface of the tub 101.

Yet furthermore, although in the above description of the embodiment the third macerating blades 123, 223 are fixedly secured onto the first macerating blades 121 and the fourth macerating blades 124, 224 are fixedly secured thereonto, the present invention is not limited to this structure. For example, it is also acceptable that the third macerating blades 123, 223 are disposed above the first macerating blades 121 to be rotatable separately from the first macerating blades 121, or that the fourth macerating blades 124, 224 are made to be rotatable separately from the first macerating blades 121.

What is claimed is:

1. A stock re-pulper for macerating stock put together with a dilute solution into a stock tub, comprising:
a first porous plate disposed in said stock tub and having first holes formed therein;
first macerating blades disposed to confront one surface of said first porous plate and made to be rotated in proximity to a first open area of said first porous plate where said first holes are formed;
a pump blade disposed to confront the other surface of said first porous plate in proximity to said first open area and made to be rotated concentrically with respect to the center of rotation of said first macerating blades;
a second porous plate disposed in said stock tub and having second holes formed therein;
second macerating blades disposed to confront one surface of said second porous plate in proximity to a second open area where said second holes are formed and made to be rotated concentrically with respect to the center of rotation of said first macerating blades; and
a drive source for rotating said first macerating blades, said pump blade and said second macerating blades.

2. The stock re-pulper according to claim 1, wherein
third macerating blades are provided above said first macerating blades and are made such that a distance from the center of rotation of said first macerating blades to an outer-circumferential end of said third macerating blades is shorter than a distance from the center of rotation of said first macerating blades to an outer-circumferential end of said first macerating blades.

3. The stock re-pulper according to claim 1, wherein
fourth macerating blades are provided above said first macerating blades and are made such that a distance from the center of rotation of said first macerating blades to an outer-circumferential end of said fourth macerating blades is shorter than a distance from the center of rotation of said first macerating blades to an outer-circumferential end of said first macerating blades, and a height of said fourth macerating blades is lower than a height of said third macerating blades.

4. The stock re-pulper according to claim 2, wherein
said first macerating blades are composed of a plurality of blades, and
said third macerating blades and said fourth macerating blades are alternately disposed above said plurality of first macerating blades.

5. The stock re-pulper according to claim 4, wherein
said second macerating blades have blade portions protruding toward said second porous plate, and
said blade portions of said second macerating blades are made such that a gap relative to said second porous plate becomes gradually wider toward a downstream side of said second porous plate.

6. The stock re-pulper according to claim 5, wherein
an open area of said second holes is smaller than an open area of said first holes.

7. The stock re-pulper according to claim 6, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

8. The stock re-pulper according to claim 7, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

9. The stock re-pulper according to claim 8, wherein
each of said second holes is formed as a round hole having a generally complete round configuration.

10. The stock re-pulper according to claim 9, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

11. The stock re-pulper according to claim 10, wherein
said second macerating blades include the plurality of blade portions and a groove portion is formed between the plurality of blade portions.

12. The stock re-pulper according to claim 6, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

13. The stock re-pulper according to claim 4, wherein
an angle made between an outer edge portion of each of said third and fourth macerating blades and an upper surface portion of said first macerating blades is set at a right angle or an acute angle.

14. The stock re-pulper according claim 11, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

15. The stock re-pulper according to claim 2, wherein
said second macerating blades have blade portions protruding toward said second porous plate, and
said blade portions of said second macerating blades are made such that a gap relative to said second porous plate becomes gradually wider toward a downstream side of said second porous plate.

16. The stock re-pulper according to claim 15, wherein
an open area of said second holes is smaller than an open area of said first holes.

17. The stock re-pulper according to claim 16, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

18. The stock re-pulper according to claim 17, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

19. The stock re-pulper according to claim 18, wherein each of said second holes is formed as a round hole having a generally complete round configuration.

20. The stock re-pulper according to claim 19, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

21. The stock re-pulper according to claim 20, wherein said second macerating blades include the plurality of blade portions and a groove portion is formed between the plurality of blade portions.

22. The stock re-pulper according to claim 16, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

23. The stock re-pulper according to claim 2, wherein
an open area of said second holes is smaller than an open area of said first holes.

24. The stock re-pulper according to claim 23, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

25. The stock re-pulper according to claim 24, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

26. The stock re-pulper according to claim 25, wherein
each of said second holes is formed as a round hole having a generally complete round configuration.

27. The stock re-pulper according to claim 26, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

28. The stock re-pulper according to claim 27, wherein
said second macerating blades include the plurality of blade portions and a groove portion is formed between the plurality of blade portions.

29. The stock re-pulper according to claim 23, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

30. The stock re-pulper according to claim 2, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

31. The stock re-pulper according to claim 30, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

32. The stock re-pulper according to claim 31, wherein
each of said second holes is formed as a round hole having a generally complete round configuration.

33. The stock re-pulper according to claim 32, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

34. The stock re-pulper according to claim 33, wherein
said second macerating blades include the plurality of blade portions and a groove portion is formed between the plurality of blade portions.

35. The stock re-pulper according to claim 2, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

36. The stock re-pulper according to claim 35, wherein
each of said second holes is formed as a round hole having a generally complete round configuration.

37. The stock re-pulper according to claim 36, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

38. The stock re-pulper according to claim 37, wherein
said second macerating blades include a plurality of blade portions and a groove portion is formed between said plurality of blade portions.

39. The stock re-pulper according to claim 2, wherein
each of said second holes is formed as a round hole having a generally complete round configuration.

40. The stock re-pulper according to claim 39, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

41. The stock re-pulper according to claim 40, wherein
said second macerating blades include a plurality of blade portions and a groove portion is formed between said plurality of blade portions.

42. The stock re-pulper according to claim 2, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

43. The stock re-pulper according to claim 42, wherein
said second macerating blades include a plurality of blade portions and a groove portion is formed between said plurality of blade portions.

44. The stock re-pulper according to claim 2, wherein
said second macerating blades include a plurality of blade portions and a groove portion is formed between said plurality of blade portions.

45. The stock re-pulper according to claim 3, wherein
said first macerating blades are composed of a plurality of blades, and
said third macerating blades and said fourth macerating blades are alternately disposed above said plurality of first macerating blades.

46. The stock re-pulper according to claim 45, wherein
said second macerating blades have blade portions protruding toward said second porous plate, and
said blade portions of said second macerating blades are made such that a gap relative to said second porous plate becomes gradually wider toward a downstream side of said second porous plate.

47. The stock re-pulper according to claim 46, wherein
an open area of said second holes is smaller than an open area of said first holes.

48. The stock re-pulper according to claim 47, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

49. The stock re-pulper according to claim 48, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

50. The stock re-pulper according to claim 49, wherein
each of said second holes is formed as a round hole having a generally complete round configuration.

51. The stock re-pulper according to claim 50, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

52. The stock re-pulper according to claim 51, wherein
said second macerating blades include the plurality of blade portions and a groove portion is formed between the plurality of blade portions.

53. The stock re-pulper according to claim 47, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

54. The stock re-pulper according to claim 45, wherein
an angle made between an outer edge portion of each of said third and fourth macerating blades and an upper surface portion of said first macerating blades is set at a right angle or an acute angle.

55. The stock re-pulper according to claim 3, wherein
said second macerating blades have blade portions protruding toward said second porous plate, and
said blade portions of said second macerating blades are made such that a gap relative to said second porous plate becomes gradually wider toward a downstream side of said second porous plate.

56. The stock re-pulper according to claim 55, wherein
an open area of said second holes is smaller than an open area of said first holes.

57. The stock re-pulper according to claim 56, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

58. The stock re-pulper according to claim 57, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

59. The stock re-pulper according to claim 58, wherein
each of said second holes is formed as a round hole having a generally complete round configuration.

60. The stock re-pulper according to claim 59, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

61. The stock re-pulper according to claim 60, wherein
said second macerating blades include a plurality of blade portions and a groove portion is formed between said plurality of blade portions.

62. The stock re-pulper according to claim 56, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

63. The stock re-pulper according to claim 3, wherein
an open area of said second holes is smaller than an open area of said first holes.

64. The stock re-pulper according to claim 63, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

65. The stock re-pulper according to claim 64, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

66. The stock re-pulper according to claim 65, wherein
each of said second holes is formed as a round hole having a generally complete round configuration.

67. The stock re-pulper according to claim 66, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

68. The stock re-pulper according to claim 67, wherein
said second macerating blades include a plurality of blade portions and a groove portion is formed between said plurality of blade portions.

69. The stock re-pulper according to claim 63, wherein
each of said first holes is formed to have a hole width in a range from 3 mm to 40 mm, and
each of said second holes is formed to have a hole width in a range from 0.15 mm to 16 mm, and
the rates of open areas of said first and second porous plates are set at values in a range from 10% to 50%.

70. The stock re-pulper according to claim 3, wherein
each of said first holes is formed as an elongated hole extending in a substantially radial direction of said first porous plate and a long axis of said elongated hole is inclined in a range from larger than 0 degree to not larger than 20 degrees with respect to said first macerating blades.

71. The stock re-pulper according to claim 70, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

72. The stock re-pulper according to claim 71, wherein
each of said second holes is formed as a round hole having a generally complete round configuration.

73. The stock re-pulper according to claim 72, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

74. The stock re-pulper according to claim 73, wherein
said second macerating blades include a plurality of blade portions and a groove portion is formed between said plurality of blade portions.

75. The stock re-pulper according to claim 3, wherein
each of said second holes is formed as an elongated hole extending in a substantially radial direction of said second porous plate and a long axis of said elongated hole is inclined in a range from larger than 0 degree to not larger than 20 degrees with respect to said second macerating blades.

76. The stock re-pulper according to claim 75, wherein
each of said second holes is formed as a round hole having a generally complete round configuration.

77. The stock re-pulper according to claim 76, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

78. The stock re-pulper according to claim 77, wherein
said second macerating blades include a plurality of blade portions and a groove portion is formed between said plurality of blade portions.

79. The stock re-pulper according to claim 3, wherein
each of said second holes is formed as a round hole having a generally complete round configuration.

80. The stock re-pulper according to claim 79, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

81. The stock re-pulper according to claim 80, wherein
said second macerating blades include a plurality of blade portions and a groove portion is formed between said plurality of blade portions.

82. The stock re-pulper according to claim 3, wherein
said second porous plate is formed into a cylindrical configuration whose longitudinal central axis coincides with the axis of rotation of said first macerating blades, and
said second macerating blades are made to be rotated on an inner-circumferential side of said second porous plate having the cylindrical configuration.

83. The stock re-pulper according to claim 82, wherein
said second macerating blades include a plurality of blade portions and a groove portion is formed between said plurality of blade portions.

84. The stock re-pulper according to claim 3, wherein
said second macerating blades include a plurality of blade portions and a groove portion is formed between said plurality of blade portions.

85. The stock re-pulper according claim 12, further comprising an output pipe which is a passage disposed on the other surface side of said second porous plate opposite to the one surface thereof and which is made to discharge the stock, after passing through said second holes from the one surface side of said second porous plate to the other surface side thereof, to the external, and circulation holes made in said first porous plate to be positioned on an outer-circumferential side of said first porous plate with respect to said first open area thereof to make communication between the other surface side of said first porous plate and the interior of said tub.

86. The stock re-pulper according claim 13, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

87. The stock re-pulper according claim 21, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

88. The stock re-pulper according claim 22, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

89. The stock re-pulper according claim 28, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

90. The stock re-pulper according claim 29, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

91. The stock re-pulper according claim 34, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

92. The stock re-pulper according claim 38, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

93. The stock re-pulper according claim 41, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

94. The stock re-pulper according claim 43, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

95. The stock re-pulper according claim 44, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

96. The stock re-pulper according claim 2, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

97. The stock re-pulper according claim 52, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

98. The stock re-pulper according claim 53, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

99. The stock re-pulper according claim 54, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

100. The stock re-pulper according claim 61, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

101. The stock re-pulper according claim 62, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

102. The stock re-pulper according claim 68, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

103. The stock re-pulper according claim 69, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

104. The stock re-pulper according claim 74, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

105. The stock re-pulper according claim 78, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

106. The stock re-pulper according claim 81, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

107. The stock re-pulper according claim 83, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

108. The stock re-pulper according claim 84, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.

109. The stock re-pulper according claim 3, further comprising
an output pipe which is a passage disposed on the other surface side of said second porous plate opposite to the one surface thereof and which is made to discharge the stock, after passing through said second holes from the one surface side of said second porous plate to the other surface side thereof, to the external, and
circulation holes made in said first porous plate to be positioned on an outer-circumferential side of said first porous plate with respect to said first open area thereof to make communication between the other surface side of said first porous plate and the interior of said tub.
